(19) United States
(12) Patent Application Publication
(10) Pub. No.: US 2019/0132456 A1
(43) Pub. Date: May 2, 2019

(54) IMAGE FORMING APPARATUS, NON-TRANSITORY RECORDING MEDIUM STORING CONTROL PROGRAM, AND CONTROL METHOD

(71) Applicant: SHARP KABUSHIKI KAISHA, Sakai City (JP)

(72) Inventors: TAKASHI SAWANO, Sakai City (JP); MAYUKO YOSHIDA, Sakai City (JP); KUMIKO OGINO, Sakai City (JP); YASUHIRO NAKAI, Sakai City (JP); MASAO SAEDA, Sakai City (JP)

(21) Appl. No.: 16/178,409

(22) Filed: Nov. 1, 2018

(30) Foreign Application Priority Data
Nov. 1, 2017 (JP) 2017-212191

(51) Int. Cl. H04N 1/00; H04N 1/10

(52) U.S. Cl. CPC H04N 1/00076; H04N 1/10; H04N 1/00408; H04N 1/00037; H04N 1/00474; H04N 1/00551

(57) ABSTRACT

An imaging forming apparatus includes at least an image reading unit and a display. The image reading unit includes a document placing table formed of a transparent plate and a document holding cover mounted above the document placing table. The image reading unit is provided with an opening and closing sensor that detects whether the document holding cover is open or closed. If the opening and closing sensor detects that the document holding cover is open, the display displays an information screen demonstrating how to place the original document.

### BACKGROUND

### 1. Field

The present disclosure relates to an image forming apparatus, a non-transitory recording medium storing a control program, and a control method, and in particular to, for example, an image forming apparatus capable of reading an original document placed on a document placing table, a non-transitory recording medium storing a control program therefor, and a control method therefor.

### 2. Description of the Related Art

An example of such a kind of the related art is disclosed in Japanese Unexamined Patent Application Publication No. 2003-309703. An image reading apparatus according to the related art reads an original document after the original document is placed, sets an image reading mode of the original document, determines the contents of the set mode, and displays information about the direction of stacking with respect to the orientation of the original document which is placed at a sheet feeding position, in accordance with the result of determining the mode contents.

However, the image reading apparatus according to the related art displays information after reading the first original document. Therefore, in a case where the original document is placed before the information is displayed, the position where an original document is placed may be inappropriate.

Therefore, it is desirable to provide a new image forming apparatus, a non-transitory recording medium storing a new control program, and a new control method.

In addition it is desirable to provide an image forming apparatus, a non-transitory recording medium storing a control program, and a control method capable of suppressing an error in a position where an original document is placed.

### SUMMARY

According to a first aspect of the present disclosure, an image forming apparatus includes: a document placing table; a reading unit that reads an image of an original document placed on the document placing table; a document holding cover that is provided on an upper surface of the document placing table so as to be openable and closable; a display; a cover detection unit; and a display control unit. The cover detection unit detects whether the document holding cover is open or closed. The display control unit causes the display to display an information screen demonstrating how to place the original document on the document placing table if the cover detection unit detects that the document holding cover is open.

According to a second aspect of the present disclosure, a non-transitory recording medium storing a control program causes a processor of an image forming apparatus to execute functions of: a cover detection unit that detects whether a document holding cover is open or closed; and a display control unit that causes a display to display an information screen demonstrating how to place an original document on a document placing table if the cover detection unit detects that the document holding cover is open. The image forming apparatus includes the document placing table, a reading unit that reads an image of the original document placed on the document placing table, the document holding cover that is provided on an upper surface of the document placing table so as to be openable and closable, and the display.

According to a third aspect of the present disclosure, a control method of an image forming apparatus includes: detecting whether a document holding cover is open or closed; and causing a display to display an information screen demonstrating how to place an original document on a document placing table if it is detected that the document holding cover is open. The image forming apparatus includes the document placing table, a reading unit that reads an image of the original document placed on the document placing table, the document holding cover that is provided on an upper surface of the document placing table so as to be openable and closable, and the display.

The above-mentioned goals, other goals, features, and advantages of the aspects of the present disclosure will become more apparent from the following detailed description of the embodiments with reference to the drawings.

### BRIEF DESCRIPTION OF THE DRAWINGS

FIG. 1 is a perspective view illustrating an external configuration of an image forming apparatus according to an embodiment of the present disclosure;

FIG. 2 is a block diagram illustrating an electrical configuration of the image forming apparatus shown in FIG. 1;

FIG. 3A is an illustrative view illustrating an example of an opening and closing sensor in a state in which a document holding cover is open, FIG. 3B is an illustrative view illustrating an example of the opening and closing sensor in a state in which the document holding cover is closed, and FIG. 3C is a top view illustrating the opening and closing sensor as viewed from the top;

FIG. 4 is an illustrative view illustrating the image reading unit in a state in which the document holding cover is open;

FIG. 5 is an illustrative view illustrating the image reading unit in a state in which the document holding cover is closed;

FIG. 6 is an illustrative view illustrating an example of a first home screen;

FIG. 7 is an illustrative view illustrating an example of an information screen;

FIG. 8 is an illustrative view illustrating an example of a memory map of a RAM shown in FIG. 2;

FIG. 9 is a flowchart illustrating an example of demonstration processing of a CPU shown in FIG. 2;

FIG. 10 is an illustrative view illustrating a second home screen in a second embodiment;

FIG. 11 is an illustrative view illustrating an example of a memory map of a RAM in the second embodiment;

FIG. 12 is a flowchart illustrating an example of demonstration processing according to the second embodiment;

FIG. 13 is an illustrative view illustrating an example of a color settings screen according to a third embodiment;

FIG. 14 is an illustrative view illustrating an example of a monochrome settings screen according to the third embodiment;

FIG. 15 is a flowchart illustrating an example of demonstration processing according to the third embodiment;

FIG. 16 is a flowchart illustrating an example of job setting processing according to the third embodiment;

FIG. 17 is an illustrative view illustrating an example of a standard mode settings screen according to a fourth embodiment;

FIG. 18 is an illustrative view illustrating an example of a non-standard mode settings screen according to the fourth embodiment;

FIG. 19 is a flowchart illustrating an example of demonstration processing according to the fourth embodiment; and

FIG. 20 is a flowchart illustrating an example of job setting processing according to the fourth embodiment.

### DESCRIPTION OF THE EMBODIMENTS

### First Embodiment

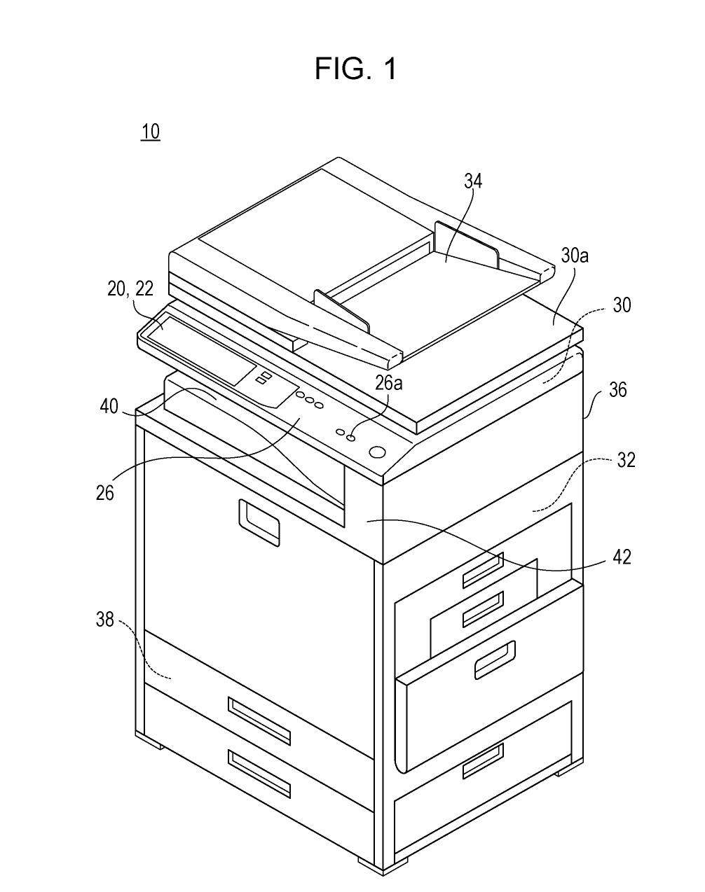

FIG. 1 is a front view illustrating an external configuration of an image forming apparatus 10 according to an embodiment of the present disclosure. Referring to FIG. 1, in the first embodiment, the image forming apparatus 10 is a multifunction peripheral (MFP) having a copying function, a printer function, a scanner function, a facsimile function, and the like. It should be noted that the present disclosure is applicable not only to a multifunction peripheral but also to an image reading apparatus or any image forming apparatus (image forming apparatus) having an image reading function (scanner function).

In this specification, it is assumed that the face opposing a standing position of a user, that is, the face, on which an operation panel 26 described later is provided, is set as the front face (front face). Under this assumption, the front-rear direction (depth direction) of the image forming apparatus 10 and its constituent members is defined. Thus, the right-left direction (lateral direction) of the image forming apparatus 10 and its constituent members is defined when the image forming apparatus 10 is viewed from a user.

The image forming apparatus 10 includes an apparatus body 36 including an image reading unit 30, an image forming unit 32, a manual sheet feeding unit 34, a sheet feeding device 38, and a sheet discharge tray 40.

The image reading unit 30 includes a document placing table (platen glass) formed of a transparent material (transparent plate) and is incorporated in the apparatus body 36. A document holding cover 30a is mounted above the platen glass with a hinge or the like interposed therebetween so as to be openable and closable. The manual sheet feeding unit 34 is provided on the document holding cover 30a. Further, an automatic document feeder (ADF) is provided on the document holding cover 30a. The ADF automatically feeds the original document placed on the manual sheet feeding unit 34. However, the manual sheet feeding unit 34 and the ADF does not have to be provided.

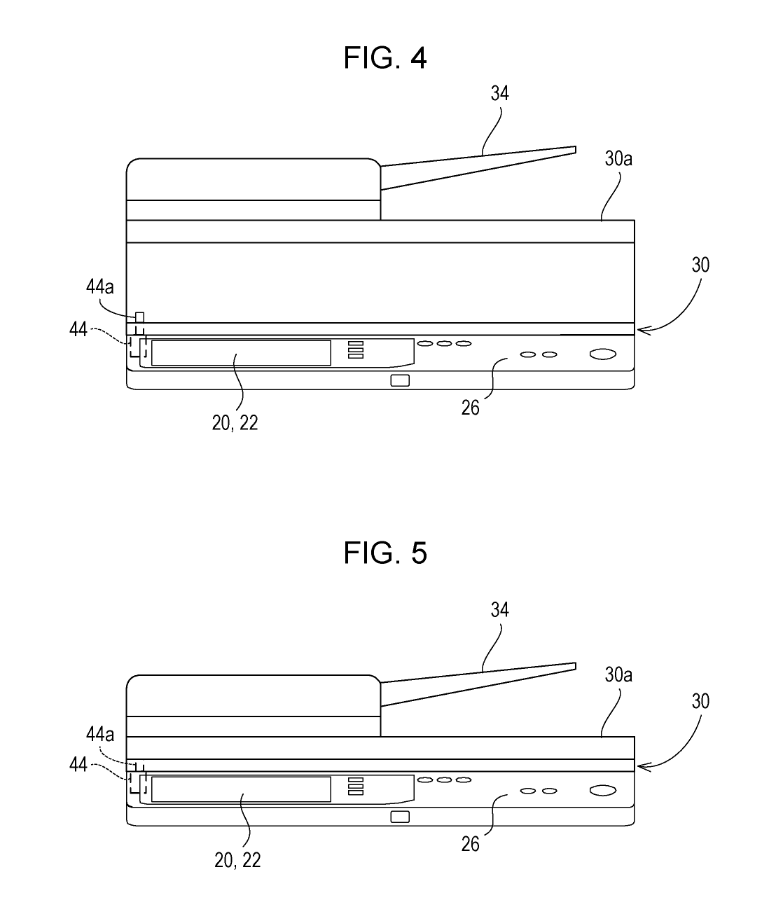

Further, the image reading unit 30 includes an opening and closing sensor 44 which detects whether the document holding cover 30a is open or closed. The opening and closing sensor 44 is provided to be closer to the rear side than the platen glass and is provided on the left side when the image reading unit 30 is viewed from the front (refer to FIGS. 4 and 5, and the like). A specific configuration of the opening and closing sensor 44 will be described later.

Further, the image reading unit 30 includes a light source, a plurality of mirrors, an imaging lens, a line sensor, and the like. The image reading unit 30 exposes the surface of the original document to a light source and guides light reflected from the surface of the original document to the imaging lens by using a plurality of mirrors. Then, the imaging lens focuses the reflected light onto the light-receiving element of the line sensor. The line sensor detects the luminance or the chromaticity of the reflected light focused on the light-receiving element and generates read image data of the image on the surface of the original document. As the line sensor, a charge coupled device (CCD), a contact image sensor (CIS), or the like is used.

The image forming unit 32 is incorporated in the apparatus body 36 and provided under the image reading unit 30. The image forming unit 32 includes a photosensitive drum, a charging device, an exposure device, a developing device, a transfer device, a fixing device, and the like. The image forming unit 32 forms an image on a printing medium (sheet) through electrophotography and discharges the sheet, on which the image is formed, to the sheet discharge tray 40. The printing medium is conveyed from the manual sheet feeding unit 34, the sheet feeding device 38, or the like. Here, as the image data for forming an image on a sheet, image data read by the image reading unit 30, image data transmitted from an external computer, or the like is used. In addition, the printing medium is not limited to a paper, and sheets other than paper sheets such as OHP film may be used.

The sheet discharge tray 40 is provided between the image reading unit 30 and the image forming unit 32. The image forming unit 32 partitions the bottom surface of the sheet discharge tray 40. The image reading unit 30 partitions the top surface of the sheet discharge tray 40. The right side surface of the connection casing 42 defines the left side surface (the left side surface as viewed from the front) of the sheet discharge tray 40. That is, the front surface side, the back surface side, and the left surface side of the sheet discharge tray 40 are open. The bottom surface of the sheet discharge tray 40 has an inclined surface that is inclined downward toward the connection casing 42.

The operation panel 26 is provided on the front side of the image reading unit 30. The operation panel 26 includes a display 22, which has a touch panel 20, and a plurality of operation buttons 26a.

The display 22 having the touch panel 20 displays software buttons, messages, and the like for accepting input of various settings or printing instructions from a user. For example, the display 22 displays an operation screen such as a home screen or a settings screen. The home screen is a screen for selecting a desired job from various jobs (operations) to be executed by the image forming apparatus 10. The settings screen is a screen for setting operation conditions of each job. However, in this first embodiment, the term “job” denotes to copy (including scanning the original document), to print, to transmit by facsimile, and the like.

The operation buttons 26a are hardware buttons and include, for example, a home button, a power saving button, a main power button, and the like. The home button is a button for displaying the home screen on the display 22. The power saving button is a button for switching between a power saving state (power saving mode) and a normal state (normal mode). In the power saving state, power consumption is limited. In the normal state, power consumption is not limited.

The term “software button” denotes, for example, a button (icon) implemented by software on the display surface of the display 22 having the touch panel 20. On the other hand, the term “hardware button” denotes a physical button.

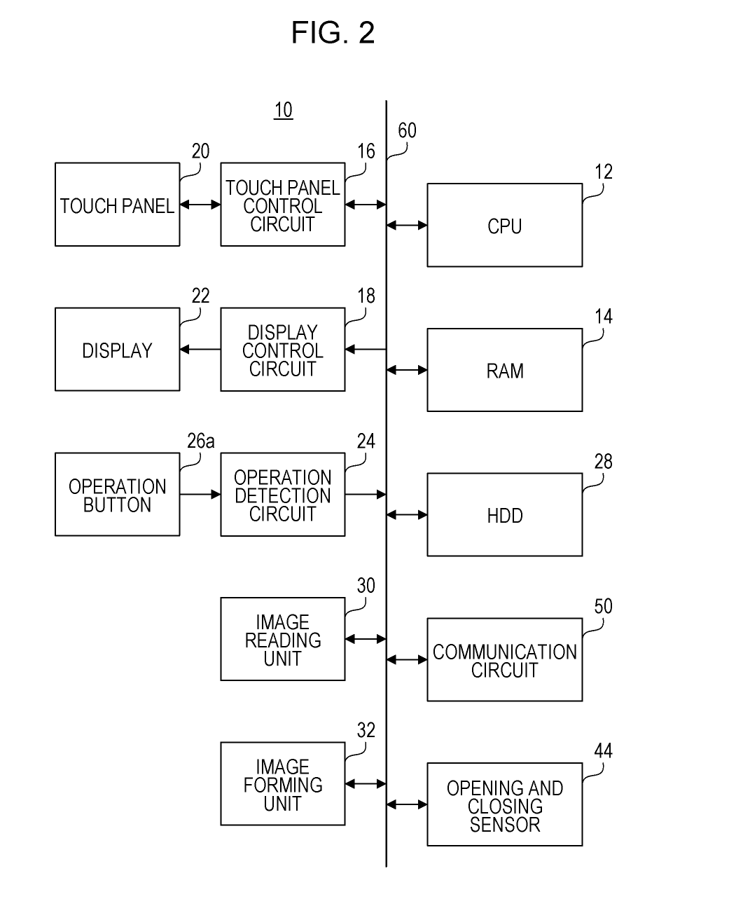

FIG. 2 is a block diagram illustrating an electrical configuration of the image forming apparatus 10 shown in FIG. 1. Referring to FIG. 2, the image forming apparatus 10 includes a CPU 12. The CPU 12 is connected to a RAM 14, an HDD 28, a touch panel control circuit 16, a display control circuit 18, an operation detection circuit 24, an image reading unit 30, an image forming unit 32, a communication circuit 50, and an opening and closing sensor 44, via a bus 60. The touch panel 20 is connected to the touch panel control circuit 16, the display 22 is connected to the display control circuit 18, and the operation buttons 26a are connected to the operation detection circuit 24.

The CPU 12 performs overall control of the image forming apparatus 10. The RAM 14 is used as a work area and a buffer area of the CPU 12.

The HDD 28 is the main storage device of the image forming apparatus 10 and appropriately stores a control program, display image data for various screens, and the like. The control program is for causing the CPU 12 to control the operation of each unit of the image forming apparatus 10. However, other nonvolatile types of memory such as SSD, flash memory, and EEPROM may be used in place of or in addition to the HDD 28.

The touch panel control circuit 16 applies a desired voltage and the like to the touch panel 20, detects a touch operation (touch input) within the touch-effective range of the touch panel 20 and outputs touch coordinate data to the CPU 12. The touch coordinate data indicates a position of the touch input.

The touch panel 20 is a general-purpose touch panel and may employ any type of touch panel such as an electrostatic capacitance type, an electromagnetic induction type, a resistive film type, or an infrared type. In the first embodiment, an electrostatic capacitance type touch panel is used as the touch panel 20, and the touch panel 20 is provided on the display surface of the display 22. However, a touch panel display, in which the touch panel 20 and the display 22 are integrally formed, may be used.

The display control circuit 18 includes a GPU, a VRAM, and the like. Under the control of the CPU 12, the GPU generates the display image data in the VRAM by using the image generation data loaded into the RAM 14 and outputs the generated display image data to the display 22. The display image data is data for displaying various screens on the display 22. As the display 22, for example, an LCD, an electro-luminescence (EL) display, or the like can be used.

The operation detection circuit 24 outputs to the CPU 12 an operation signal or operation data corresponding to the operation of the above-mentioned operation button 26a.

The communication circuit 50 is a communication circuit for connecting to a network such as the Internet. The communication circuit 50 is a wired communication circuit or a wireless communication circuit and communicates with an external computer such as a server over a network in accordance with a command from the CPU 12.

As described above, the opening and closing sensor 44 is a sensor that detects whether the document holding cover 30a is open or closed and includes an actuator 44a and an optical sensor 44b. However, in the first embodiment, whether the document holding cover 30a is open (open state) or closed (closed state) is detected in accordance with the output of the opening and closing sensor 44.

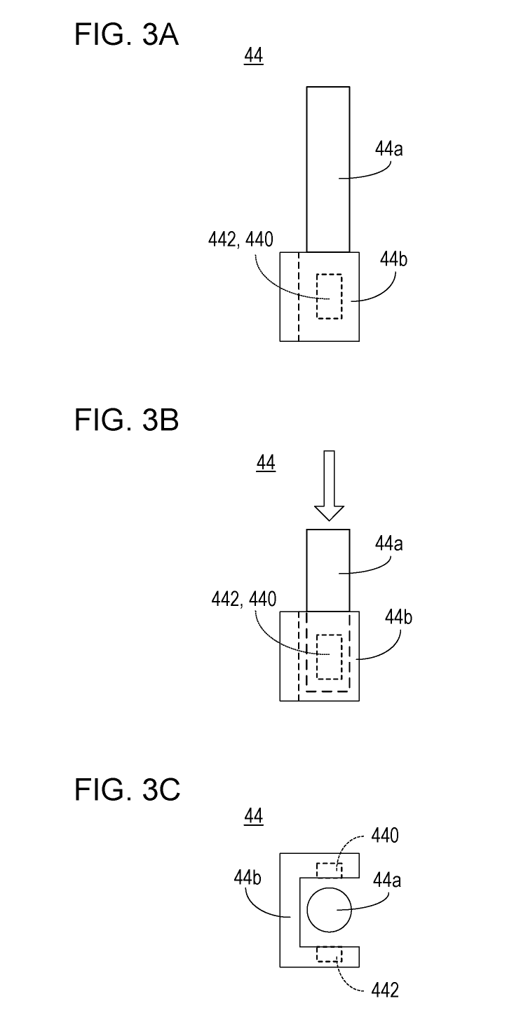

FIGS. 3A, 3B, and 3C are schematic diagrams illustrating a configuration of the opening and closing sensor 44. FIG. 4 is an illustrative view illustrating the image reading unit 30 in a state in which the document holding cover 30a is open. FIG. 5 is an illustrative view illustrating the image reading unit 30 in a state in which the document holding cover 30a is closed.

The actuator 44a is movable in the vertical direction and is urged upward by an urging member which is not shown. The upper end portion of the actuator 44a comes into contact with the lower surface of the document holding cover 30a. Thus, as shown in FIGS. 3A and 3B, the actuator 44a moves vertically in accordance with the opening and closing of the document holding cover 30a. As shown in FIG. 3C, the optical sensor 44b resembles a U shape rotated clockwise by 90 degrees in top view as viewed from the top in the movement direction of the actuator 44a. A light-emitting unit 440 is provided on one side of the two sides of the optical sensor 44b opposing each other. A light-receiving unit 442 is provided on the other side.

As shown in FIG. 4, in a state in which the document holding cover 30a is open (open state), as the lower surface of the document holding cover 30a moves upward, the actuator 44a moves upward. Therefore, as shown in FIG. 3A, the light-receiving unit 442 receives light which is output from a light-emitting unit 440 of the optical sensor 44b. In the first embodiment, in order to determine whether or not the document holding cover 30a is closed, the amount of light received by the light-receiving unit 442 in the open state is measured in advance.

On the other hand, as shown in FIG. 5, in a state in which the document holding cover 30a is closed (closed state), as the lower surface of the document holding cover 30a moves downward, the document holding cover 30a presses the actuator 44a down. Therefore, as shown in FIG. 3B, the actuator 44a blocks the light which is output from the light-emitting unit 440 of the optical sensor 44b. Thus, the light-receiving unit 442 does not receive the light, or an amount of received light is reduced.

Here, as the actuator 44a moves, the amount of light, which is received by the light-receiving unit 442 after being output from the light-emitting unit 440, changes. Therefore, after the document holding cover 30a is open, the amount of received light starts to decrease and becomes equal to or less than a predetermined amount. In this case, it is detected that the document holding cover 30a is closed.

It should be noted that the electrical configuration of the image forming apparatus 10 shown in FIG. 2 is just an example, and the present disclosure is not limited to this. For example, the image forming apparatus 10 may be provided with a connecting portion (memory slot or the like) and the like to which various recording media (such as SD card and USB memory) can be attached.

In the image forming apparatus 10 having such a configuration, the display 22 displays various operation screens, and a user instruction is accepted as a touch input via the touch panel 20. For example, the display 22 displays, as the operation screen, a settings screen for various jobs to be executed by the image forming apparatus 10. A specific job setting operation (job setting) is performed on the settings screen, and each operation is executed by the image forming apparatus 10. In the image forming apparatus according to the related art, in accordance with the job setting operation performed by a user, information about a position of an original document, which is placed on the platen glass, and about a direction of stacking with respect to an orientation of the original document may be displayed.

However, in the image forming apparatus according to the related art, the information is displayed after the job setting operation is performed. Therefore, in a case where an original document is placed before the job setting operation is performed, the information is not displayed. Therefore, the user may position the original document incorrectly.

Therefore, in the first embodiment, in a state in which the document holding cover 30a is open, the display 22 displays an information screen demonstrating how to place the original document.

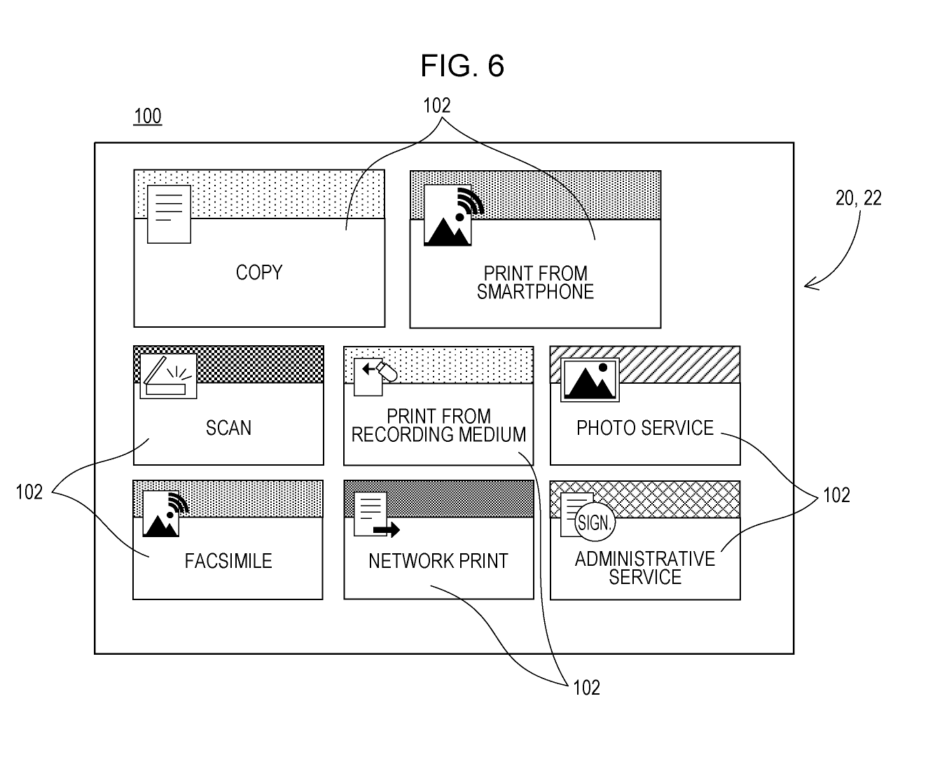

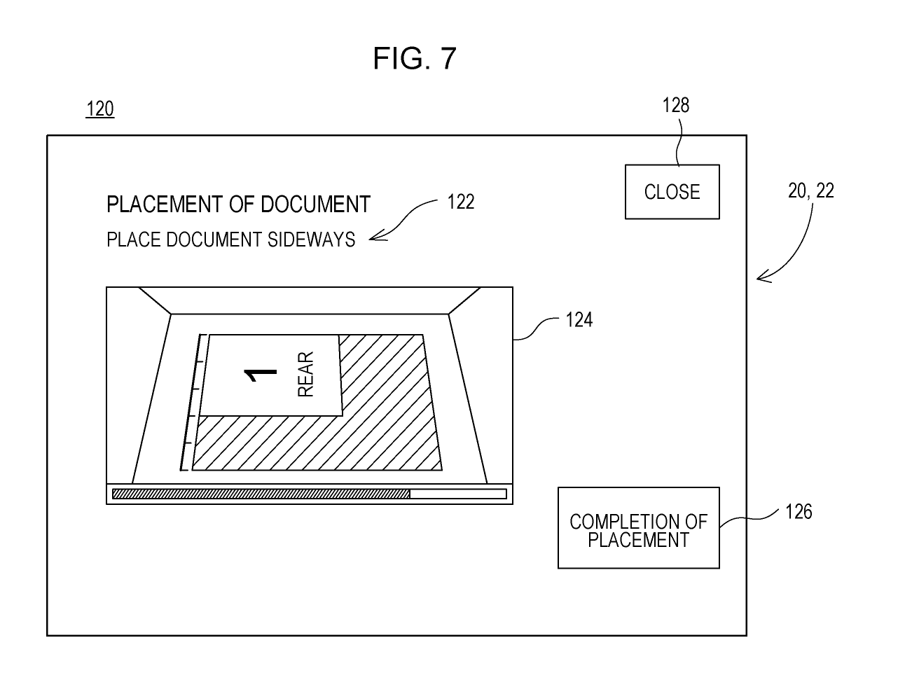

An exemplary operation of the image forming apparatus 10 will be described below with reference to FIGS. 6 and 7. FIG. 6 is an illustrative view illustrating an example of a first home screen 100. FIG. 7 is an illustrative view illustrating an example of an information screen 120.

In a case where the main power supply of the image forming apparatus 10 is switched on and the image forming apparatus 10 is in a standby state in which each job can be executed, the display 22 of the image forming apparatus 10 displays the first home screen 100 shown in FIG. 6. The first home screen 100 is a screen for selecting various jobs. On the first home screen 100, a plurality of icons 102 for selecting respective jobs are displayed. Here, the jobs selectable on the first home screen 100 include copy, scan, print from a smartphone, print from a recording medium, network print, photo service, administrative service, facsimile transmission, and the like.

Each of the plurality of icons 102 is an image enclosed by a substantially rectangular frame and functions as a software button. The jobs such as copy, scan, facsimile, print from the recording medium”, network print, photograph service, and administrative service are assigned to respective icons of the plurality of icons 102.

Here, when the document holding cover 30a is open in a state in which the first home screen 100 is displayed, the display 22 displays the information screen 120 demonstrating how to place the original document. That is, when it is detected that the document holding cover 30a is open in accordance with the output of the opening and closing sensor 44, the information screen 120 is displayed.

As shown in FIG. 7, the information screen 120 displays a message 122 to inform a user how to place the original document, a rectangular moving image display area 124, a completion icon 126, and a close icon 128.

For example, the information screen 120 displays a message 122 such as “Place the original document sideways”.

In the moving image display area 124, a moving image indicating how to place the original document is displayed. Specifically, in the moving image display area 124, a moving image indicating the orientation and position (the inner left corner of the platen glass) of the original document is displayed. Here, the moving image is repeatedly reproduced (displayed) until the completion icon 126 or the close icon 128 is touched (selected).

According to the message 122 and the moving image displayed in the moving image display area 124, the method of placing the original document is presented to the user. Accordingly, the user is able to appropriately place the original document on the platen glass while referring to the method of placing the original document displayed on the information screen 120.

The completion icon 126 and the close icon 128 are icons for closing the information screen 120. When the completion icon 126 or the close icon 128 is touched, the information screen 120 is closed (hidden), and the display 22 displays the first home screen 100 shown in FIG. 6.

Further, when the document holding cover 30a is closed with the information screen 120 being displayed, the information screen 120 is closed, and the display 22 displays the first home screen 100.

The above-mentioned operation of the image forming apparatus 10 is implemented by the CPU 12 executing the information processing program loaded into the RAM 14. Specific processing will be described later with reference to a flow chart.

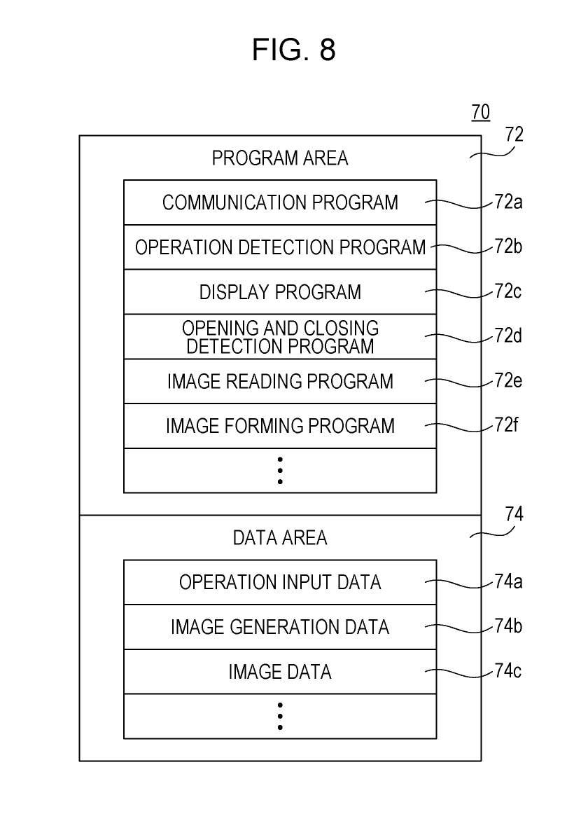

FIG. 8 is an illustrative view illustrating an example of a memory map 70 of the RAM 14 of the image forming apparatus 10 shown in FIG. 2. As shown in FIG. 8, the RAM 14 includes a program area 72 and a data area 74. As described above, the information processing program is loaded into the program area 72. This information processing program includes a communication program 72a, an operation detection program 72b, a display program 72c, an opening and closing detection program 72d, an image reading program 72e, and an image forming program 72f.

The communication program 72a is for communicating with an external computer or the like via the communication circuit 50.

The operation detection program 72b is for detecting an operation for each part of the image forming apparatus 10. For example, the operation detection program 72b is for acquiring the touch coordinate data and detecting that the software button is being operated. The touch coordinate data is output from the touch panel 20, and the software button is included in various screens displayed on the display 22. The operation detection program 72b is also for detecting an operation input received from the operation button 26a.

The display program 72c is for generating display image data from the image generation data 74b to be described later and outputting the display image data to the display 22. The display image data corresponds to various screens to be displayed on the display 22 such as the first home screen 100. Further, when it is detected that the document holding cover 30a is open, the display program 72c is also a program for generating display image data from the image generation data 74b and outputting the data to the display 22. The display image data corresponds to the information screen 120.

The opening and closing detection program 72d is for detecting whether the document holding cover 30a is open or closed. Specifically, the opening and closing detection program 72d determines (detects) in accordance with the output of the opening and closing sensor 44 whether the document holding cover 30a is open or closed.

The image reading program 72e is for controlling the image reading unit 30 such that it reads (scans) the image of the original document placed on the platen glass and for outputting the image signal (scanned image data) corresponding to the read image.

The image forming program 72f is for controlling the image forming unit 32 such that it forms a color or monochrome image on a printing medium (sheet) in accordance with image data such as the scanned image data.

Although not shown, programs for selecting and executing various operations of the image forming apparatus 10 are also loaded into the program area 72.

Operation input data 74a, image generation data 74b, image data 74c, and the like are loaded into the data area 74 of the RAM 14.

The operation input data 74a is at least one of operation data and touch coordinate data detected (acquired) in accordance with the operation detection program 72b, for example. At least one of the detected operation data and touch coordinate data is loaded chronologically.

The image generation data 74b is data such as polygon data or texture data for generating display image data which corresponds to various screens such as the first home screen 100 and the information screen 120 displayed on the display 22. The image generation data 74b also includes image data for a software button and the like.

The image data 74c is scanned image data which is read by the image reading unit 30, image data which is input from the external computer, or the like.

Although not shown, other data for execution of the information processing program may be loaded into the data area 74, and a timer (or a counter) or a register for execution of the information processing program may be provided.

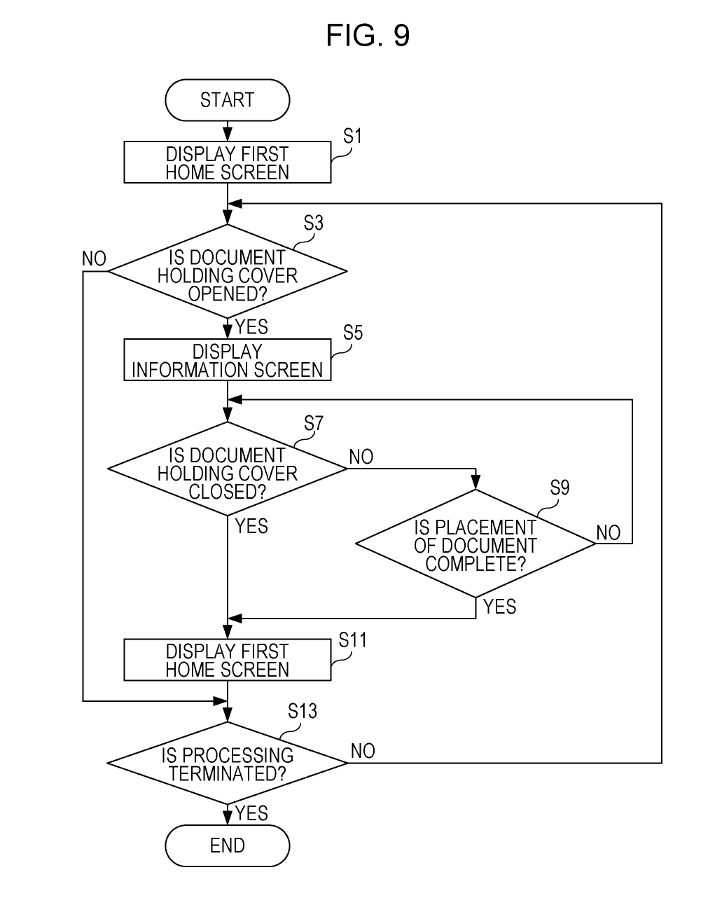

FIG. 9 is a flowchart illustrating an example of demonstration processing of the CPU 12 of the image forming apparatus 10 shown in FIG. 2. This demonstration processing is started when the power supply of the image forming apparatus 10 is switched on or recovered from the power saving mode. It should be noted that the demonstration processing is executed in parallel with the information processing for executing various operations of the image forming apparatus 10. Examples of the operations include an operation of setting operation conditions of each job and an operation of executing each job. As shown in FIG. 9, when the demonstration processing is started, the CPU 12 displays the first home screen 100 on the display 22 in step S1 and determines in step S3 whether or not the document holding cover 30a is open. Here, in accordance with the output of the opening and closing sensor 44, it is determined whether or not the document holding cover 30a is open.

If “NO” in step S3, that is, if the document holding cover 30a is not open (i.e., closed), the processing proceeds to step S11 described later. In contrast, if “YES” in step S3, that is, if the document holding cover 30a is open, the display 22 displays the information screen 120 in step S5, and it is determined in step S7 whether or not the document holding cover 30a is closed. Here, in accordance with the output of the opening and closing sensor 44, it is determined whether or not the document holding cover 30a is closed.

If “NO” in step S7, that is, if the document holding cover 30a is not closed (i.e., open), it is determined in step S9 whether or not placement of the original document is complete. Here, it is determined whether or not the completion icon 126 has been touched. If “NO” in step S9, that is, if the placement of the original document is not complete, the processing returns to step S7. In contrast, if “YES” in step S9, that is, if the placement of the original document is complete, the processing proceeds to step S11.

In contrast, if “YES” in step S7, that is, if the document holding cover 30a is closed, the processing proceeds to step S11.

Subsequently, in step S11, the display 22 displays the first home screen 100, and the processing proceeds to step S13, and it is determined in step S13 whether or not to terminate the demonstration processing. Here, it is determined whether or not to switch off the power supply of the image forming apparatus 10 or switch to the power saving mode. If “NO” in step S13, that is, if the demonstration processing is not terminated, the processing returns to step S3 described above. In contrast, if “YES” in step S13, the demonstration processing is terminated.

According to the first embodiment, in a state in which the document holding cover 30a is open, the display 22 displays the information screen 120 demonstrating how to place the original document. Therefore, the user is able to place the original document at the correct position while referring to the information screen 120. Therefore, according to the first embodiment, it is possible to suppress an error in the position where the original document is placed.

According to the first embodiment, in a state in which the document holding cover 30a is closed, the information screen 120 is closed. Therefore, various jobs can be selected on the first home screen 100, and the operation conditions of each job can be set on another operation screen.

According to the first embodiment, when the completion icon 126 is provided on the information screen 120 and the completion icon 126 is touched, the information screen 120 is closed. Therefore, various jobs can be selected on the first home screen 100, and the operation conditions of each job can be set on another operation screen.

### Second Embodiment

In the image forming apparatus 10 according to a second embodiment, when the document holding cover 30a is open or closed and an original document is present on the platen glass, the display 22 displays a second home screen 140 instead of the first home screen 100. Except this configuration, the second embodiment is the same as the first embodiment. Thus, the contents different from those in the first embodiment will be described, and redundant description will be omitted.

In the second embodiment, when the document holding cover 30a is closed after the document holding cover 30a is open, it is detected whether or not an original document is present. A specific method of detecting presence of the original document is as follows.

As a first detection method, the following method can be adopted. When the document holding cover 30a is open or closed, pre-scanning before scanning (main scanning) of an original document is executed. Thereby, in accordance with the chromaticity and the luminance of the reflected light imaged on the light-receiving element of the line sensor, it is determined whether or not the original document is present on the platen glass.

As a second detection method, the following method can be adopted. A dedicated document detection sensor is provided in the image reading unit 30, and it is determined whether or not an original document is present on the platen glass, in accordance with the output of the document detection sensor. As the document detection sensor, a reflective photoelectric sensor or a transmissive photoelectric sensor may be used. For example, the document detection sensor is provided at a position where an original document is placed, such as a position in the vicinity of the inner left corner of the platen glass.

Further, as a third detection method, there is a method of determining whether an original document is present on the platen glass in accordance with the opening or closing of the document holding cover 30a. In this case, in a state in which the document holding cover 30a is closed after the document holding cover 30a is open, it is presumed that the original document is placed on the platen glass. As a result, it is determined that the original document is placed on the platen glass.

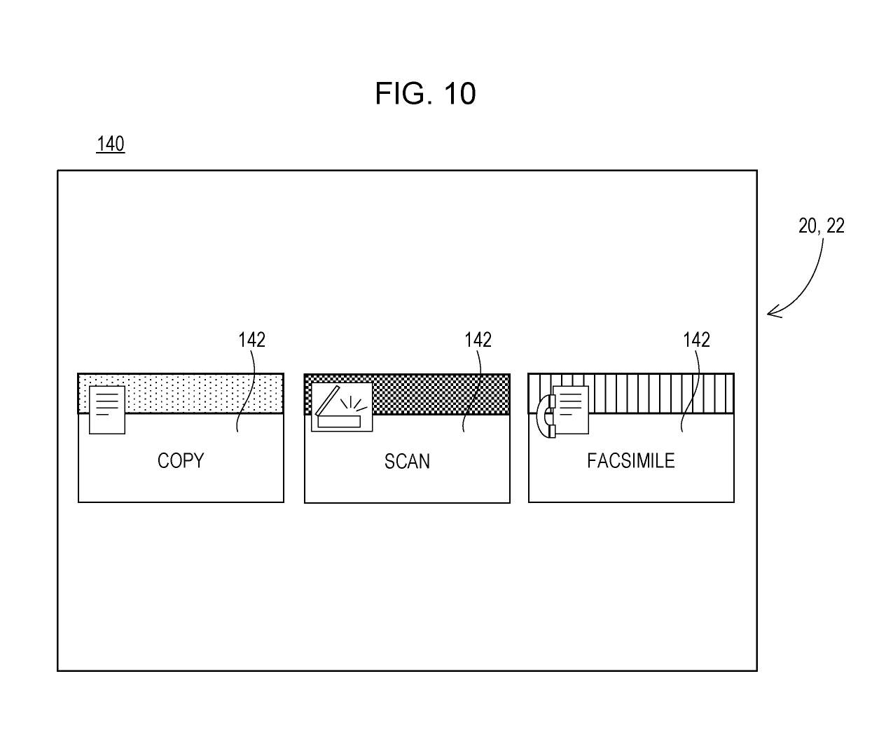

FIG. 10 is an illustrative view illustrating the second home screen 140 in the second embodiment. If presence of the original document is detected by the above-mentioned method, when the information screen 120 is closed, the display 22 displays the second home screen (first operation screen) 140 shown in FIG. 10, instead of the first home screen 100.

Similarly to the first home screen 100, the second home screen 140 is an operation screen for selecting various jobs. However, the second home screen 140 displays only the icon 142 corresponding to the job (corresponding to the first type operation mode) using the original document. For example, the second home screen 140 displays only the icon 142 (corresponding to the first type icon) for selecting copy, scan, and transmission of facsimile. In contrast, the second home screen 140 does not display icons corresponding to jobs such as print from a smartphone, print from a recording medium, network print, photo service, and administrative service which can be selected on the first home screen 100. That is, on the second home screen 140, it is possible to select only jobs using the original document.

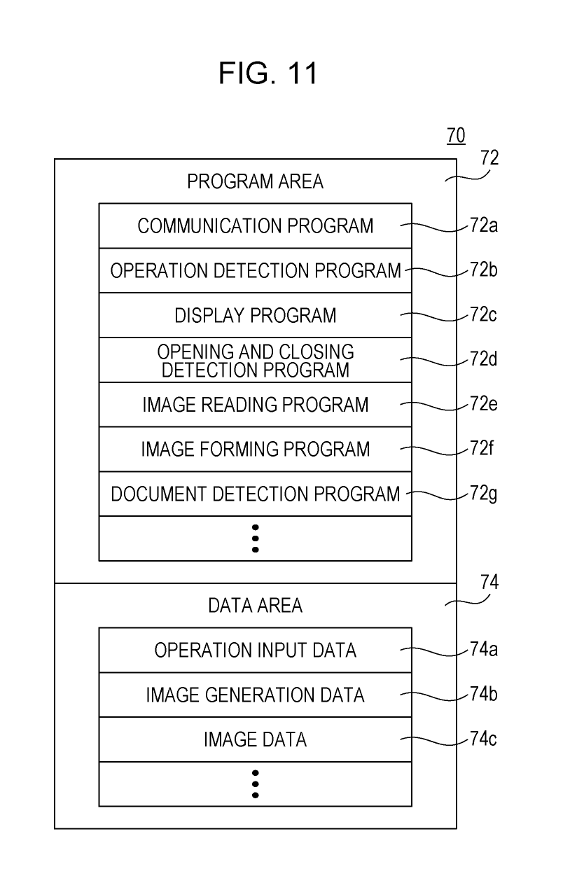

FIG. 11 is an illustrative view illustrating an example of the memory map 70 of the RAM 14 of the second embodiment. As shown in FIG. 4, the program area 72 of the RAM 14 stores the information processing program as described above. The information processing program includes a communication program 72a, an operation detection program 72b, a display program 72c, an opening and closing detection program 72d, an image reading program 72e, an image forming program 72f, and a document detection program 72g. It should be noted that the communication program 72a, the operation detection program 72b, the display program 72c, the opening and closing detection program 72d, the image reading program 72e, and the image forming program 72f are the same as those in the first embodiment, and thus description thereof is omitted.

The document detection program 72g is for detecting an original document placed on the platen glass in the above-mentioned manner.

Similarly to the first embodiment, the data area 74 of the RAM 14 stores operation input data 74a, image generation data 74b, and image data 74c.

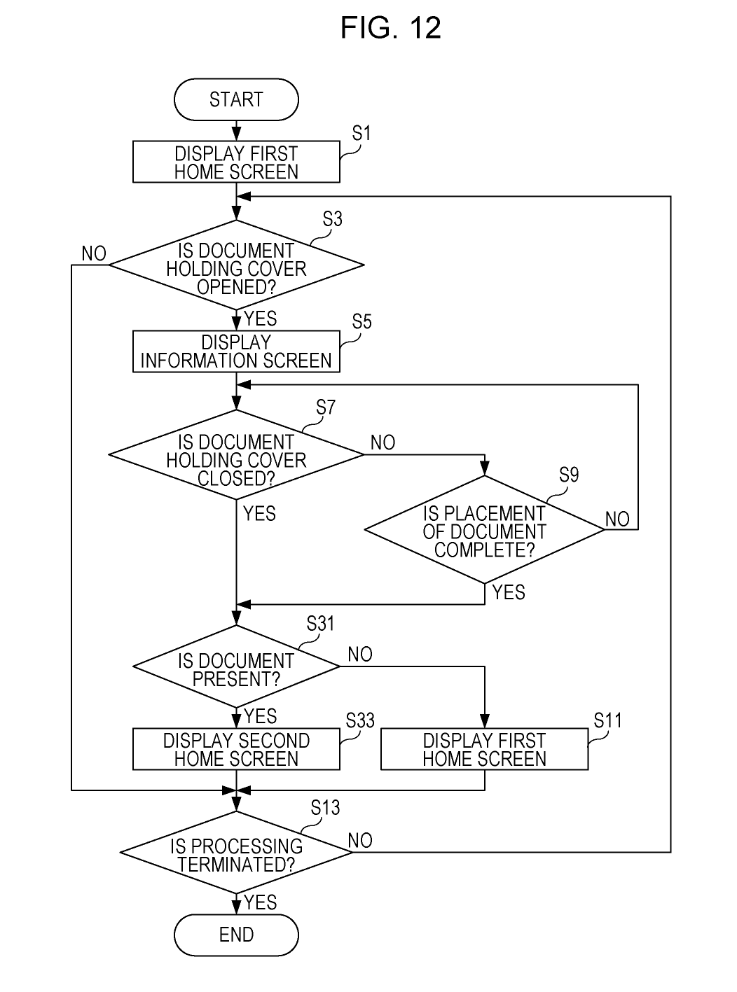

FIG. 12 is a flowchart illustrating an example of demonstration processing of the CPU 12 of the image forming apparatus 10 according to the second embodiment. Hereinafter, the demonstration processing of the image forming apparatus 10 according to the second embodiment will be described with reference to a flow chart. The elements in the same processing as the demonstration processing described in the first embodiment are represented by the same reference numerals, and redundant contents thereof will be omitted or briefly described.

As shown in FIG. 12, when the demonstration processing is started, if “YES” in step S7, the CPU 12 advances the processing to step S31. If “YES” in step S9, the processing proceeds to step S31. In step S31, it is determined whether or not an original document is present on the platen glass.

If “NO” in step S31, that is, if the original document is not present on the platen glass, the processing proceeds to step S11. In contrast, if “YES” in step S31, that is, if an original document is present on the platen glass, the display 22 displays the second home screen 140 in step S33, and the processing proceeds to step S13.

The contents of the processing up to step S9 and the processing in and after step S11 are the same as those of the first embodiment, and therefore the description thereof is omitted.

According to the second embodiment, in a case where the document holding cover 30a is open or closed and the original document is present on the platen glass, the display 22 displays the second home screen 140 capable of selecting only the job using the original document. Therefore, a user is able to easily select a job and can be prevented from performing erroneous operation.

In the second embodiment, the second home screen 140 is displayed only when the document holding cover 30a is open or closed. Therefore, if a residual original document is present on the platen glass, the second home screen 140 is not displayed in place of the first home screen 100. In this case, the display 22 may display a notification screen for notifying the user that the residual original document is present.

### Third Embodiment

In the image forming apparatus 10 according to a third embodiment, when the document holding cover 30a is open or closed, document information is acquired by executing pre-scanning. In accordance with the acquired document information, the contents of the settings screen for setting the operation conditions of each job are changeable. Except this configuration, the third embodiment is the same as the first embodiment. Thus, the contents different from those in the first embodiment will be described, and redundant description will be omitted.

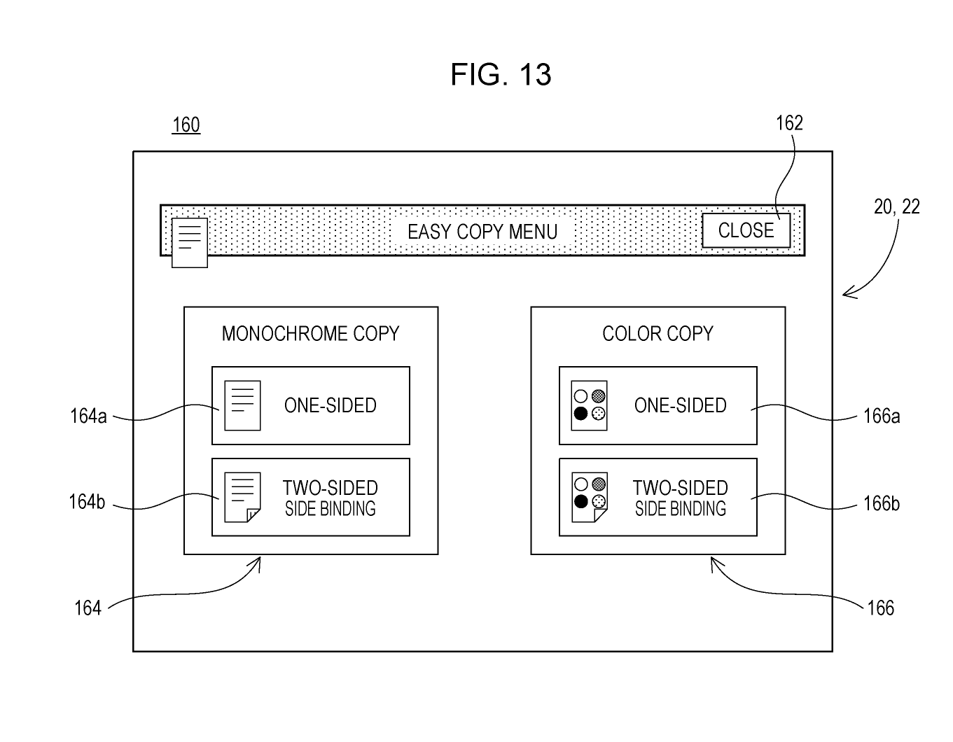

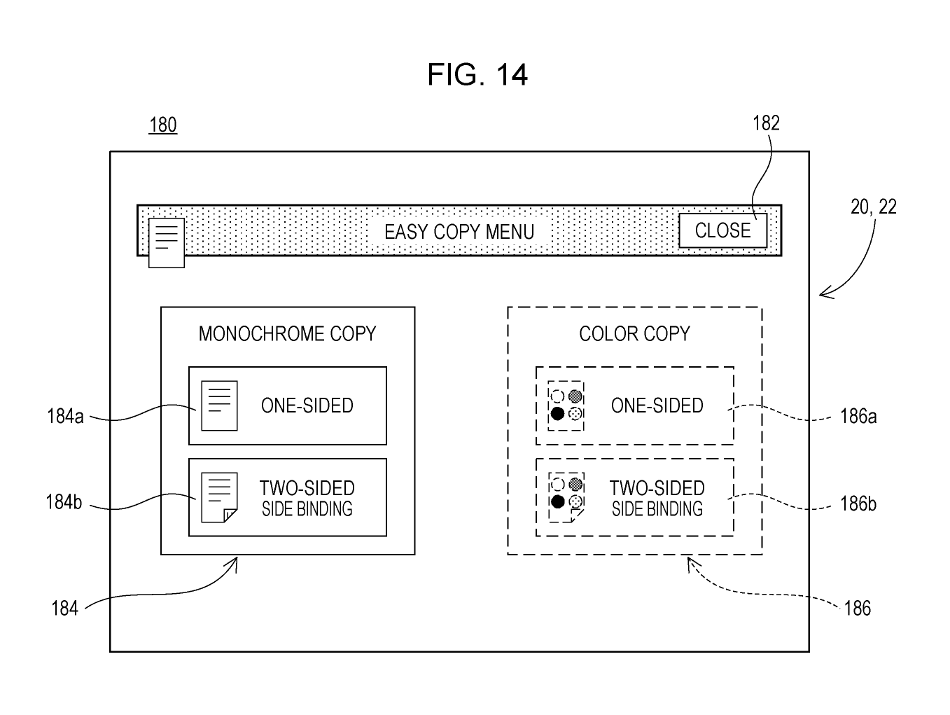

FIG. 13 is an illustrative view illustrating an example of a color settings screen 160 of the third embodiment. FIG. 14 is an illustrative view illustrating an example of a monochrome settings screen 180 of the third embodiment.

First, in the image forming apparatus 10 according to the third embodiment, when the document holding cover 30a is open or closed, pre-scanning is executed, and the document information is acquired from the original document on the platen glass. The document information includes color information on whether the original document is a color original document or a monochrome original document.

The method of determining whether the original document is a color original document or a monochrome original document is described in Japanese Unexamined Patent Application Publication No. 2011-015172 filed by the applicants of the present disclosure. Thus, the method is hereby incorporated by reference.

Next, in accordance with the acquired color information, the mode for setting the setting conditions of the job (job setting operation) is set. In a case where the original document is a color original document, a normal (color) mode is set. In the normal mode, operations on setting items relating to the color original document are accepted. In contrast, in a case where the original document is a monochrome original document, a monochrome mode is set. In the monochrome mode, operations on the setting items relating to the color original document are not accepted.

When the icon 102 included in the first home screen 100 is touched (when a job is selected), the display 22 sequentially displays the settings screens for setting the job assigned to the icon 102. However, different settings screens are displayed between a case where the normal mode is set and a case where the monochrome mode is set. Hereinafter, a case where a copy job is selected will be described as an example.

For example, in the case where the normal mode is set, a copy job may be selected on the first home screen 100. Then, as shown in FIG. 13, the display 22 displays the color settings screen 160 for setting copy jobs.

The color settings screen 160 includes a close icon 162, a monochrome setting area 164, and a color setting area 166. An operation of closing the color settings screen 160 is assigned to the close icon 162. When the close icon 162 is touched, the color settings screen 160 is closed (hidden), and the display 22 displays the first home screen 100. In addition, when the close icon 162 is touched, the setting for the copy job is initialized. It is the same for the close icons 182, 202, and 222 to be described later.

The monochrome setting area 164 is for setting one-sided copy and two-sided copy in monochrome (black and white) copy. The monochrome setting area 164 includes a one-sided icon 164a to which one-sided copy setting is assigned and a two-sided-use icon 164b to which two-sided copy setting is assigned.

The color setting area 166 is for setting the one-sided copy and two-sided copy in color copy. The color setting area 166 includes a one-sided icon 166a to which the one-sided copy setting is assigned and a two-sided-use icon 166b to which the two-sided copy setting is assigned.

In this color settings screen 160, when one of the one-sided icon 164a, the two-sided icon 164b, the one-sided icon 166a, and the two-sided icon 166b is touched, the setting of copy job (setting of the monochrome copy and color copy or setting of the one-sided copy and two-sided copy) is determined. In such a manner, on the color settings screen 160, it is possible to select monochrome copy or color copy.

In contrast, in a case where the monochrome mode is set, the icons 102 to which the copy job is assigned on the first home screen 100 may be touched. Then, as shown in FIG. 14, the display 22 displays the monochrome settings screen 180 for setting the copy job.

The monochrome settings screen 180 includes a close icon 182, a monochrome setting area 184, and a color setting area 186.

The monochrome setting area 184 corresponds to the monochrome setting area 164 of the above-mentioned color settings screen 160 and includes a one-sided icon 184a and a two-side icon 184b. The color setting area 186 corresponds to the color setting area 166 of the above-mentioned color settings screen 160 and includes a one-sided icon 186a and a two-sided icon 186b. However, on the monochrome settings screen 180, the color setting area 186 is inactivated. Thus, the one-sided icon 186a and the two-side icon 186b are not selectable. Therefore, on the monochrome settings screen 180, although the monochrome copy can be selected, the color copy is not selectable.

Then, until setting of the copy job is complete, the display 22 sequentially displays a plurality of settings screens for the copy job, and the setting of the copy job is determined in accordance with the user operation. When the setting of the copy job is determined, the copy job is executed in accordance with the setting of the copy job.

Hereinafter, the demonstration processing according to the third embodiment will be described with reference to the flow chart. The elements in the same processing as the demonstration processing described in the first embodiment are represented by the same reference numerals, and redundant contents thereof will be omitted or briefly described.

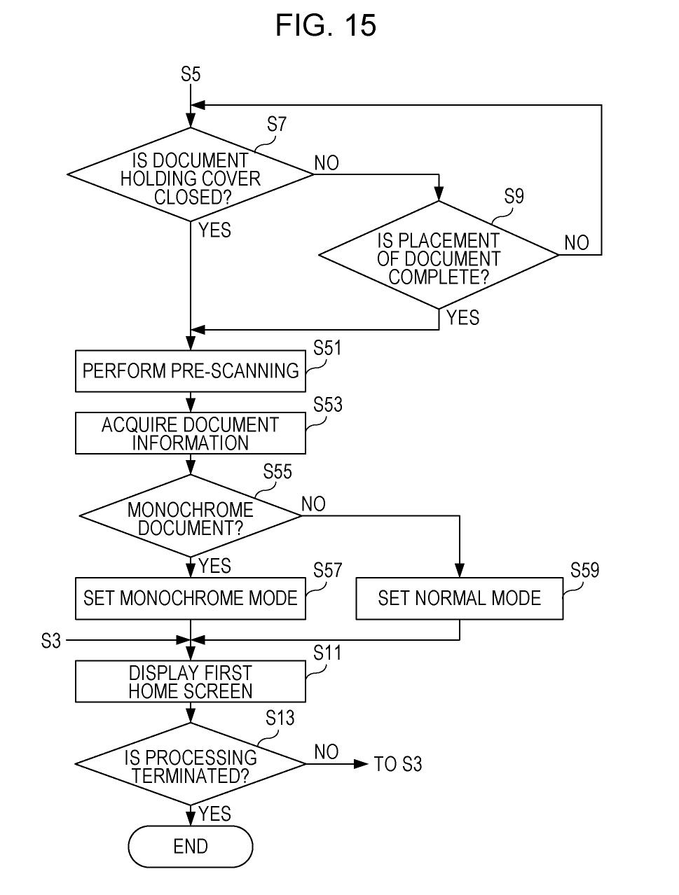

FIG. 15 is a flowchart illustrating an example of demonstration processing according to the third embodiment. As shown in FIG. 15, when the demonstration processing is started, if “YES” in step S7, the CPU 12 advances the processing to step S51. If “YES” in step S9, the processing proceeds to step S51.

In step S51, pre-scanning is performed, and in step S53, the document information is acquired. Here, as the document information, color information about whether the original document is a color original document or a monochrome original document is acquired.

Subsequently, in step S55, it is determined whether or not the original document is a monochrome original document in accordance with the color information. If “YES” in step S55, that is, if it is determined that the original document is a monochrome original document, a monochrome mode is set in step S57, and the processing proceeds to step S11. In contrast, if “NO” in step S55, that is, if it is determined that the original document is not a monochrome original document (if it is determined that the original document is a color original document), the normal mode is set in step S59, and the processing proceeds to step S11.

The contents of the processing up to step S9 and the processing in and after step S11 are the same as those of the first embodiment, and therefore the description thereof is omitted.

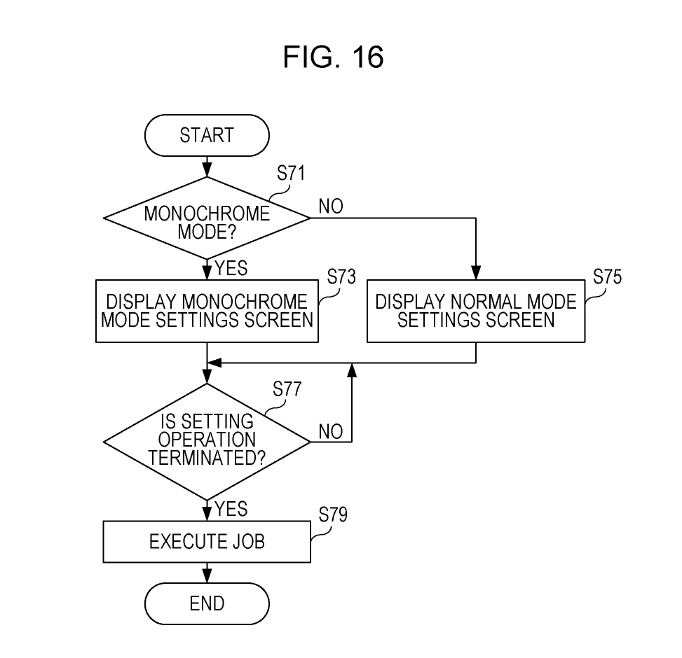

Next, the job setting processing will be described. FIG. 16 is a flowchart illustrating an example of the job setting processing of the third embodiment. The job setting processing is started when the icons 102 included in the first home screen 100 is touched. That is, the job setting processing is started when a job is selected.

As shown in FIG. 16, when the job setting processing is started, the CPU 12 determines whether or not the monochrome mode is set in step S71. If “YES” in step S71, that is, if it is determined that the monochrome mode is set, the display 22 displays a monochrome mode settings screen in step S73, and the processing proceeds to step S77. In step S73, for example, the display 22 displays the above-mentioned monochrome settings screen 180 and the like.

In contrast, if “NO” in step S71, that is, if it is determined that the monochrome mode is not set (if it is determined that the normal mode is set), the display 22 displays the normal mode settings screen in step S75, and the processing proceeds to step S77. In step S75, for example, the display 22 displays the above-mentioned color settings screen 160 and the like.

Subsequently, in step S77, it is determined whether or not the setting of the job is terminated. Here, it is determined whether or not the setting for the selected job is determined. If “NO” in step S77, that is, if it is determined that setting of the job is not terminated, the processing returns to the same step S77. In contrast, if “YES” in step S77, that is, if it is determined that the setting of the job is terminated, the job is executed in step S79, and the job setting processing is terminated.

According to the third embodiment, when the document holding cover 30a is open or closed, the pre-scanning is performed. In accordance with the document information acquired by the pre-scanning, the contents of the settings screen for setting the operation conditions of each job are changed. Therefore, in accordance with the contents of the original document, it is possible to present an appropriate settings screen to a user.

According to the third embodiment, when the original document is a monochrome original document in accordance with the color information acquired by the pre-scan, a monochrome mode that does not accept an operation on setting items relating to the color original document is set. Therefore, it is possible to suppress erroneous operation.

It should be noted that the mode shown in the third embodiment can also be adopted in combination with the second embodiment.

### Fourth Embodiment

In the image forming apparatus 10 according to a fourth embodiment, when the document holding cover 30a is open or closed, size information of the original document is acquired by executing pre-scanning. In accordance with the acquired size information of the original document, the contents of the settings screen for setting the operation conditions of each job are changeable. Except this configuration, the fourth embodiment is the same as the first embodiment. Thus, the contents different from those in the first embodiment will be described, and redundant description will be omitted.

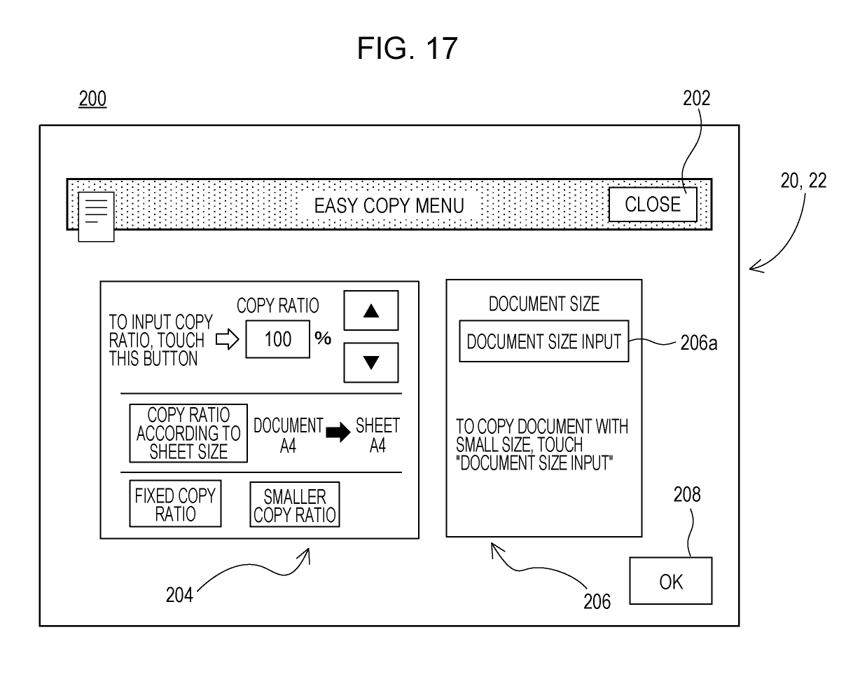

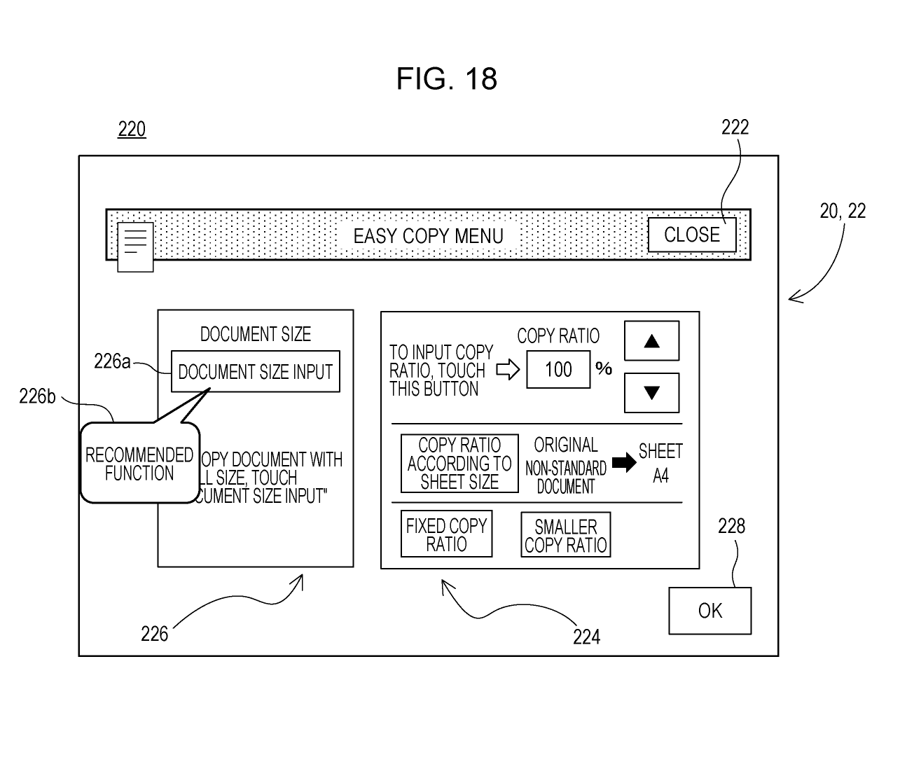

FIG. 17 is an illustrative view illustrating an example of a standard mode settings screen 200 of the fourth embodiment. FIG. 18 is an illustrative view illustrating an example of a non-standard mode settings screen 220 of the fourth embodiment.

First, in the image forming apparatus 10 according to the fourth embodiment, when the document holding cover 30a is open or closed, pre-scanning is performed, and the document information is acquired from the original document on the platen glass. The document information includes the size information of the original document about whether the original document is a standard size original document or a non-standard size original document.

The method of acquiring the size information of the original document by executing pre-scanning is described in Japanese Unexamined Patent Application Publication No. 2010-141857 filed by the applicants of the present disclosure. Thus, the method is hereby incorporated by reference. Then, the image forming apparatus 10 compares the size of the detected original document with the standard size, determines whether the original document is a standard size original document or a non-standard size original document, and acquires the size information.

Next, according to the acquired size information, in a case of the standard size original document, a standard mode is set. In the standard mode, a normal settings screen (operation screen) is displayed. In contrast, in a case of the non-standard size original document, a non-standard mode is set. In the non-standard mode, a settings screen configured such that the size of the original document is easily set is displayed.

When a job is selected on the first home screen 100, the display 22 sequentially displays settings screens for setting the selected job. However, different settings screens are displayed between a case where the standard mode is set and a case where the non-standard mode is set. Hereinafter, a case where a copy job is selected will be described as an example.

For example, in a case where the standard mode is set, a copy job may be selected on the first home screen 100. Then, as shown in FIG. 17, the display 22 displays the standard mode settings screen 200.

The standard mode settings screen 200 is for setting the document size and copy ratio and includes a close icon 202, a copy ratio setting area 204, an document size setting area 206, and an OK icon 208.

The copy ratio setting area 204 is for setting a ratio of the original document to the copy (copy ratio) and is placed on the left side (left end) of the standard mode settings screen 200. For example, the copy ratio setting area 204 is provided with a text box to which a numerical value corresponding to the copy ratio is input, an icon corresponding to the copy ratio suitable for a print sheet, and icons corresponding to preset ratios. Therefore, a user is able to set the copy ratio by inputting a numerical value in the text box or selecting an icon.

The document size setting area 206 is for setting the document size and is placed on the right side (right end) of the standard mode settings screen 200. In the document size setting area 206, an input icon 206a for inputting the document size is provided. When the input icon 206a is touched, an input screen for inputting the document size is displayed, and the document size is set in accordance with the user operation.

The OK icon 208 can be set to confirm settings on the document size and copy ratio and displaying the next settings screen. It is the same for the close OK icon 228 to be described later.

On the other hand, in a case where the non-standard mode is set, a copy job may be selected on the first home screen 100. Then, as shown in FIG. 18, the display 22 displays the non-standard mode settings screen 220.

The non-standard mode settings screen 220 includes a close icon 222, a copy ratio setting area 224, an document size setting area 226, and an OK icon 228. The copy ratio setting area 224 corresponds to the copy ratio setting area 204 of the above-mentioned standard mode settings screen 200. Further, the document size setting area 226 corresponds to the document size setting area 206 of the above-mentioned standard mode settings screen 200.

The copy ratio setting area 224 is placed on the right side (right end) of the standard mode settings screen 200, and the document size setting area 226 is placed on the left side (left end) of the non-standard mode settings screen 220. The document size setting area 226 is placed on the left side in order to make the document size setting area 226 noticeable.

A balloon image 226b is provided on the input icon 226a of the document size setting area 226. In the balloon image 226b, a message “recommended operation” is displayed. This balloon image 226b is provided to make the document size setting area 226 or the input icon 226a noticeable.

The document size setting area 226 is indicated by an appropriate color different from the copy ratio setting area 224. For example, when the copy ratio setting area 224 is indicated by only a color of white and black, the document size setting area 226 is indicated by a color such as red or blue other than white and black. The reason for this is that the document size setting area 226 is made noticeable.

Hereinafter, the demonstration processing according to the fourth embodiment will be described with reference to the flow chart. The elements in the same processing as the demonstration processing described in the first embodiment are represented by the same reference numerals, and redundant contents thereof will be omitted or briefly described.

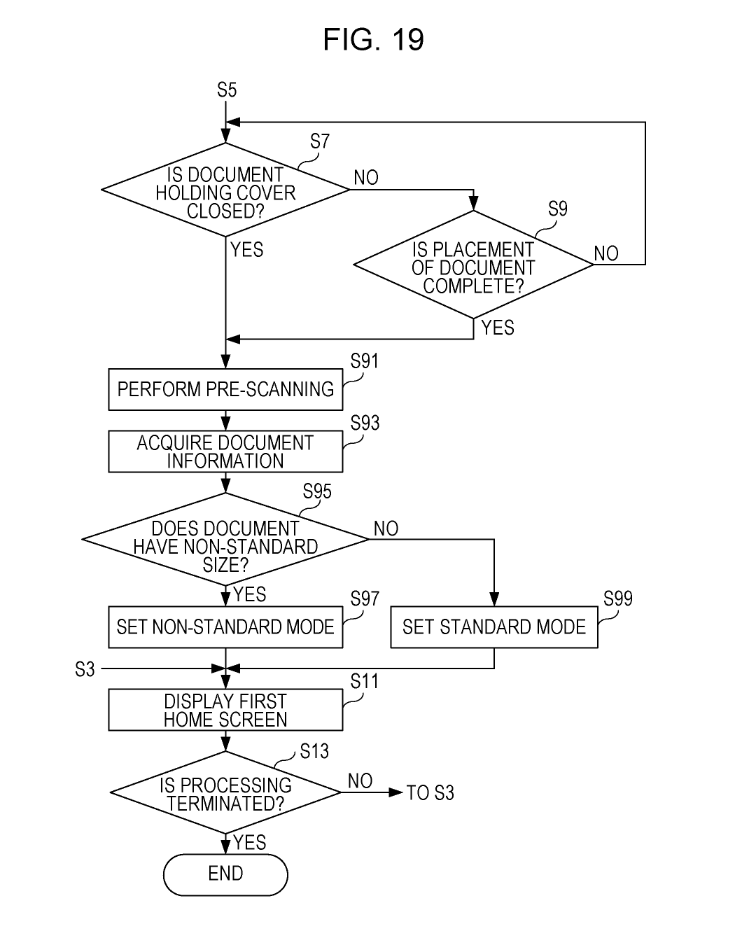

FIG. 19 is a flowchart illustrating an example of demonstration processing according to the fourth embodiment. As shown in FIG. 19, when the demonstration processing is started, if “YES” in step S7, the CPU 12 advances the processing to step S91. If “YES” in step S9, the processing proceeds to step S91.

In step S91, pre-scanning is performed, and in step S93, the document information is acquired. In this case, size information of the original document about whether the original document is a standard size original document or a non-standard size original document is acquired as the document information.

Subsequently, in step S95, it is determined whether or not the original document is a non-standard size original document in accordance with the size information of the original document. If “YES” in step S95, that is, if it is determined that the original document is a non-standard size original document, the non-standard mode is set in step S97, and the processing proceeds to step S11. In contrast, if “NO” in step S95, that is, if it is determined that the original document is not a non-standard size original document (if it is determined that the original document is an original document of a standard size), the standard mode is set in step S99, and the processing proceeds to step S11.

The contents of the processing up to step S9 and the processing in and after step S11 are the same as those of the first embodiment, and therefore the description thereof is omitted.

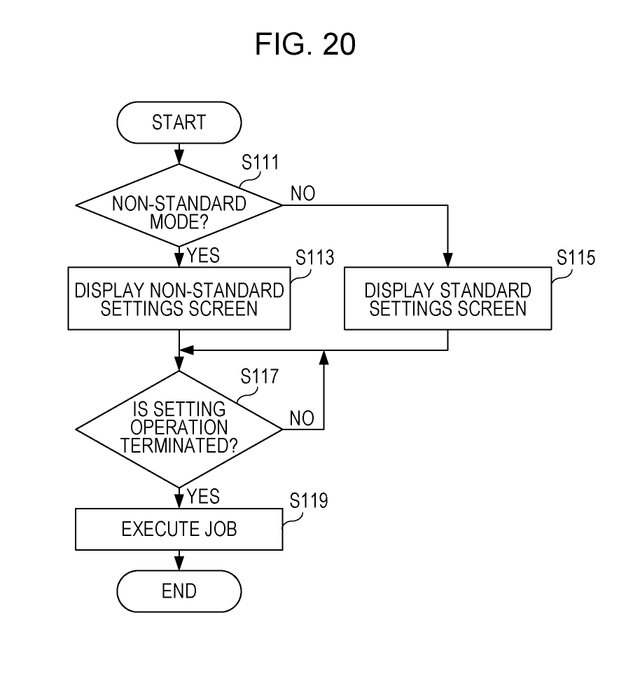

Next, the job setting processing will be described. FIG. 20 is a flowchart illustrating an example of the job setting processing of the fourth embodiment. As shown in FIG. 20, when the CPU 12 starts the job setting processing, in step S111, the CPU 12 determines whether a non-standard mode is set. If “YES” in step S111, that is, if it is determined that the non-standard mode is set, the display 22 displays a non-standard mode settings screen in step S113, and the processing proceeds to step S77. In step S113, for example, the display 22 displays the above-mentioned non-standard mode settings screen 220 and the like.

In contrast, if “NO” in step S111, that is, if it is determined that the non-standard mode is not set (if it is determined that the standard mode is set), the display 22 displays the standard mode settings screen in step S115, and the processing proceeds to step S117. In step S115, for example, the display 22 displays the above-mentioned standard mode settings screen 200 and the like.

Subsequently, in step S117, it is determined whether or not the setting of the job is terminated. If “NO” in step S117, that is, if it is determined that setting of the job is not terminated, the processing returns to the same step S117. In contrast, if “YES” in step S117, that is, if it is determined that the setting of the job is terminated, the job is executed in step S119, and the job setting processing is terminated.

According to the fourth embodiment, the original document is a non-standard size original document in accordance with the size information acquired by the pre-scanning, the non-standard mode settings screen 220 is placed and displayed to make the document size setting area 226, which is for setting the document size, noticeable. Therefore, it is easy to change the setting of the document size, and this configuration is convenient for a user.

The aspect shown in the fourth embodiment can also be adopted in combination with the second embodiment and the third embodiment.

The numerical values, screens, specific configurations, and the like mentioned in the above embodiments are just examples and may be appropriately changed in accordance with actual products.

As long as the same result can be obtained in each step of the flow charts mentioned in the above embodiments, the order of processing may be appropriately changed.

The present disclosure contains subject matter related to that disclosed in Japanese Priority Patent Application JP 2017-212191 filed in the Japan Patent Office on Nov. 1, 2017, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image forming apparatus comprising:
a document placing table;
a reading unit that reads an image of an original document placed on the document placing table;
a document holding cover that is provided on an upper surface of the document placing table so as to be openable and closable;
a display;
a cover detection unit that detects whether the document holding cover is open or closed; and
a display control unit that causes the display to display an information screen demonstrating how to place the original document on the document placing table if the cover detection unit detects that the document holding cover is open.

2. The image forming apparatus according to claim 1, wherein the display control unit hides the information screen when the cover detection unit detects that the document holding cover is closed in a state in which the information screen is displayed on the display.

3. The image forming apparatus according to claim 1, further comprising a document detecting unit that detects whether or not the original document is placed on the document placing table.

4. The image forming apparatus according to claim 3, further comprising a document information acquisition unit that acquires document information by causing the reading unit to perform pre-scanning if the document detecting unit detects that the original document is present on the document placing table.

5. The image forming apparatus according to claim 4, further comprising
a first setting unit that sets, in accordance with color information, a monochrome setting mode that does not accept an operation for setting items relating to a color original document if the original document is a monochrome original document,
wherein the document information includes the color information about whether the original document is the color original document or the monochrome original document.

6. The image forming apparatus according to claim 4, further comprising
a second setting unit that sets a non-standard mode for reading a non-standard size original document if the original document is the non-standard size original document, in accordance with size information,
wherein the document information includes the size information about whether the original document is a standard size original document or the non-standard size original document.

7. The image forming apparatus according to claim 3,
wherein a plurality of operation modes are provided, and
wherein the display control unit causes the display to display a first operation screen including a first type icon that is assigned to a first type operation mode using the image read by the reading unit among a plurality of icons assigned to each of the plurality of operation modes if the document detection unit detects that the original document is present on the document placing table.

8. A non-transitory recording medium storing a control program for causing a processor of an image forming apparatus to execute functions of:
a cover detection unit that detects whether a document holding cover is open or closed; and
a display control unit that causes a display to display an information screen demonstrating how to place an original document on a document placing table if the cover detection unit detects that the document holding cover is open,
wherein the image forming apparatus includes the document placing table, a reading unit that reads an image of the original document placed on the document placing table, the document holding cover that is provided on an upper surface of the document placing table so as to be openable and closable, and the display.

9. A control method of an image forming apparatus comprising:
detecting whether a document holding cover is open or closed; and
causing a display to display an information screen demonstrating how to place an original document on a document placing table if it is detected that the document holding cover is open,
wherein the image forming apparatus includes the document placing table, a reading unit that reads an image of the original document placed on the document placing table, the document holding cover that is provided on an upper surface of the document placing table so as to be openable and closable, and the display.
